(19) United States
(12) Patent Application Publication
(10) Pub. No.: US 2018/0345152 A1
(43) Pub. Date: Dec. 6, 2018

(54) Automatic Rating System and Method

(71) Applicants: Jianan Duan, Foster City, CA (US); Kip Turner, Foster City, CA (US)

(72) Inventors: Jianan Duan, Foster City, CA (US); Kip Turner, Foster City, CA (US)

(73) Assignee: Roblox Corporation, San Mateo, CA (US)

(21) Appl. No.: 15/609,905

(22) Filed: May 31, 2017

(51) Int. Cl. A63F 13/85; A63F 13/87; A63F 13/352; A63F 13/79; A63F 13/70; G06F 17/30

(52) U.S. Cl. CPC A63F 13/85; A63F 13/87; A63F 13/352; G06F 17/3084; A63F 13/70; G06F 17/30073; G06F 17/3082; A63F 13/79

(57) ABSTRACT

An automated ratings system operates on a network-connected computerized server couple to a data repository storing standards for images, words and phrases for comparison, executing software from a non-transitory medium on a processor in the server. A video stream of a presentation to be rated is received and played, text, images, and voice words and phrases are compared with the standards stored in the data repository, and a rating is generated by a rating module for the presentation based on presence and quantity of the standard images, words and phrases noted in the presentation to be rated.

### BACKGROUND OF THE INVENTION

### 1. Field of the Invention

The present invention is in the field of online media consumption including three-dimensional (3D) and virtual reality (VR) games, and pertains particularly to methods and apparatus for rating content suitability for viewers.

### 2. Discussion of the State of the Art

Online media, including publicly accessible games, virtual worlds, and like media products require appropriate age ratings based on content. Movies, videos, and other products, including online games, are rated for such as levels of violence, levels of profanity, levels of obscenity, and so on to prevent age-inappropriate viewers from having unfettered access to the rated media.

A challenge with rating online video games is that it typically requires human intervention and review to analyze content of a product to enable rating and categorization of the product for access, viewing, and interaction. Another challenge is that for online games, in-game chat might also be considered in content rating, because the chat transcripts may be visible at certain points in the game. Manually analyzing and rating video game content for age appropriate viewing may be impractical and cost-prohibitive for a game provider that may host a very large number of games. Moreover, many rated games may be updated by developers with new content that may cause a change in rating category or a requirement for further analysis to keep a same rating.

Therefore, what is clearly needed is an automated system and process for rating and categorizing video games and other media content for age appropriate viewing.

### BRIEF SUMMARY OF THE INVENTION

In one embodiment of the invention an automated ratings system is provided, comprising a network-connected computerized server, software executing from a non-transitory medium on a processor in the server, and a data repository storing standards for images, words and phrases for comparison. A video stream of a presentation to be rated is received and played, text, images, and voice words and phrases are compared with the standards stored in the data repository, and a rating is generated by a rating module for the presentation based on presence and quantity of the standard images, words and phrases noted in the presentation to be rated.

In one embodiment of the system the presentation is a video game, including in-game-communication between players, and words and phrases noted in the communication are used in rating. Also in one embodiment, the communication is through a chat application. Also in one embodiment communication between players is recorded and archived, and the system searches and uses content in the archived communication in the rating process. And in one embodiment, the presentation is a video game displaying objects having names and descriptions in a database, and the system extracts and considers the names and descriptions in the rating process.

In one embodiment of the system the software comprises a text extractor and parser, a text recognition module, an image recognition module, a text rating module, and an image rating module. Also in one embodiment, a rating is determined separately for image, text and voice, and then combined by the rating module to determine an overall rating. Also in one embodiment, certain images, words and phrases stored as standards are associated with a number, the rating module determines the instances of use in the presentation to be rated of the certain images, words and phrases, combines the numbers in a predetermined manner, and uses the combined numbers against a scale of age to generate an age appropriate rating for the presentation. In one embodiment, the standards and the predetermined manner are editable. And in one embodiment voice words and phrases are converted to text in the comparison and rating.

In one embodiment, presentations, including video games, are stored and played from a presentation engine hosted by a provider, and a presentation is automatically rated when first stored on the server for access. Also in one embodiment, the presentation engine monitors editing of presentations, and presentations are re-rated after any instance of editing. And in one embodiment, presentations, including video games, are promoted on a web page hosted by the provider, enabling consumers to link to a consume the presentations, and wherein a rating determined by the rating engine is prominently displayed in the promotion.

In another aspect of the invention, an automated ratings method is provided, comprising playing a video stream to be rated by a player operating in a network-connected computerized server, comparing, by execution of software on a processor in the computerized server, text, images and voice words and phrases in the presentation, to standards stored in a data repository coupled to the computerized server, and generating a rating by a rating module based on presence and quantity of the standard images, words and phrases noted in the presentation to be rated.

In one embodiment of the method the presentation is a video game, including in-game-communication between players, and words and phrases noted in the communication are used in rating. Also in one embodiment, the communication is through a chat application. Also in one embodiment, communication between players is recorded and archived, and the system searches and uses content in the archived communication in the rating process. Also in one embodiment, the presentation is a video game displaying objects having names and descriptions in a database, and the system extracts and considers the names and descriptions in the rating process. In one embodiment, the software comprises a text extractor and parser, a text recognition module, an image recognition module, a text rating module, and an image rating module. And in one embodiment a rating is determined separately for image, text and voice, and then combined by the rating module to determine an overall rating.

In one embodiment of the method, certain images, words and phrases stored as standards are associated with a number, the rating module determines the instances of use in the presentation to be rated of the certain images, words and phrases, combines the numbers in a predetermined manner, and uses the combined numbers against a scale of age to generate an age appropriate rating for the presentation. Also in one embodiment, the standards and the predetermined manner are editable. Also in one embodiment voice words and phrases extracted are converted to text in the comparison and rating. Also in one embodiment, presentations, including video games, are stored and played from a presentation engine hosted by a provider, and a presentation is automatically rated when first stored on the server for access. Also in one embodiment, the presentation engine monitors editing of presentations, and presentations are re-rated after any instance of editing. And in one embodiment, presentations, including video games, are selectable by linked indicia on a web page hosted by the provider, enabling consumers to link to and consume the presentations, and wherein a rating determined by the rating engine is prominently displayed in the indicia.

### BRIEF DESCRIPTION OF THE SEVERAL VIEWS OF THE DRAWINGS

FIG. 1 is an architectural overview of a communications network supporting automated video game addition according to an embodiment of the present invention.

FIG. 2 is a block diagram depicting automated rating by analyzing a video game stream according to an embodiment of the present invention.

FIG. 3 is a process flow chart depicting steps for accessing video games for the purpose of rating according to one aspect of practice of the present invention.

### DETAILED DESCRIPTION OF THE INVENTION

In various embodiments described in enabling detail below, the inventors provide a unique system and method for applying rating information to online video games. The present invention is described using the following examples, which may describe more than one relevant embodiment falling within the scope of the invention. Further, although rating video games is employed as an example, the method may be employed for rating other content in some embodiments.

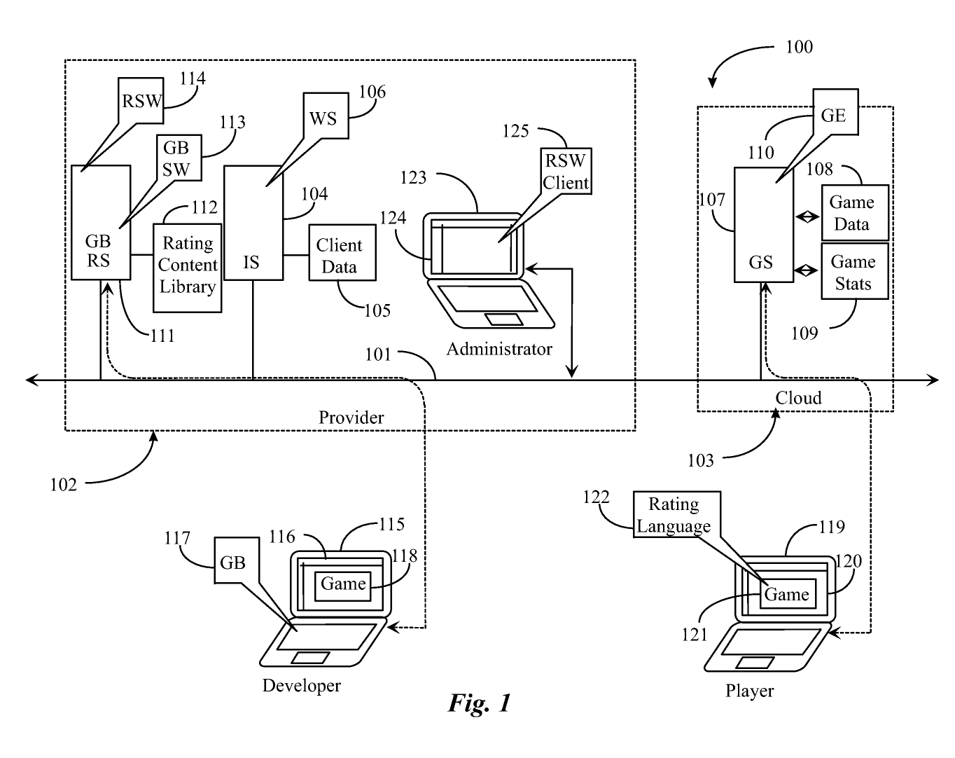

FIG. 1 is an architectural overview of a communications network 100 supporting automated video game content rating according to an embodiment of the present invention. Communications network 100 includes the Internet network as is depicted herein by a network backbone 101. Network backbone 101 represents all of the lines, equipment and access points that make up the Internet as a whole including any connected sub networks. Therefore, there are no geographic limitations on the practice of the present invention.

Internet network 101 may be a wide area network (WAN) other than the Internet without departing from the spirit and scope of the present invention. Sub networks that may be connected to Internet backbone 101 are not specifically illustrated herein but may be assumed present, and may take the form of an Ethernet network, a local area network (LAN), a municipal area network (MAN) or any wireless network communications carrier or a wireless fidelity network (Wi-Fi).

An online content provider domain 102 (Provider) may be an enterprise adapted for providing online media, such as live video games to customers or clients of the provider. Players may access the provider in this example through a Website (WS) 106 hosted on an information server (IS) 104. IS 104 has connection to network backbone 101. IS 104 may be maintained and operated solely by the provider or by an agent of the provider. IS 104 may also be owned and maintained by a third party performing Web hosting, whereby the provider has created a domain by leasing space for a Website such as WS 106.

WS 106 represents an access point for current and new clients of the provider, where those clients may register, establish accounts, play online games, chat, communicate in other ways, and access resources to build games, among potentially other activities. IS 104 has connection to at least one data repository 105 adapted to store client data about clients or customers of the provider enterprise. Data about clients may include residence information, account data, billing information and history, current status (member, etc.), client profile information, and any other data deemed appropriate to store about a client.

A client of provider 102 may log into WS 106 and access game link lists with which they may interact to select games to play. Selection of a game by a client in good standing may cause a connection to a game server 107, running a game engine 110 adapted to stream video games to client-operated devices and appliances over the Internet. In this example, a player/client operating a laptop 119 has a session connection open to server 107 and game engine 110, and is in the process of playing a video game 121 using a browser application 120. Provider 102 may host games created by game software developers such as one operating a laptop 115. The developer operating laptop 115 may be a member of provider site or domain 102, and may be a member of a game builder's network supported by WS 106.

Provider 102 may procure cloud services (Cloud) 103 for storing and serving games controlled for access by provider 102. Game server 107 has connection to at least one data repository, such as data repository 108 that may contain game data (games for service). Game server 107 has connection to at least one data repository, such as data repository 109, that may contain game statistics (stats). Game stats may include historical data and real time or current data associated with running game instances. Statistics and information, such as who is currently playing a game, and historical activity stats attributed to player histories, game activities, ratings history, current content rating, development history and author data, and so on. Some data about a video game may be streamed for presentation to a gaming device operated by a player, such as laptop 119, such as rating information 122 displayed at the beginning or during game display of game 121. Rating information may inform a player of what levels of certain subject matter the current game includes, and or thane appropriate age for viewing and interacting with that particular game.

In this embodiment, provider 102 maintains a game build rating server (GBRS) 111 executing a game rating software (RSW) application 114. The possible number of games requiring content rating may be very high, and manually rating the games may be very impractical. Therefore, SW 114 is adapted to be programmed to automatically rate video game content controlled by provider 102. Rating server 111 may also function as a game build (GB) server and may include game build software (GBSW) 113. A developer operating laptop 115 may have a local game build client application (GB) 117. GB 117 may be part of a larger client application that is browser based and enables the developer to access the provider both as a game-playing client (player) and as a game-building client. In this example, it may be assumed that game 118 is just finished build and the developer is connected in session to rating server 111 for the purpose of registering the new game for play review, beta play, and content rating services.

Rating server 111 has connection to at least one data repository, such as data repository 112, that may contain a rating content library. The rating content library may include all of the data required to enable recognition of and analysis of video game content, including game objects (embedded text), in-game chat transcripts (text), sound objects (speech word recognition), and images or image scenes (Image recognition).

In one embodiment, a developer may build a new game, such as game 118, using GB SW and browser-based application 116 on laptop 115 while in session with GBRS 111. The developer may upload game 118 to register the game for play on the provider's game site. Amongst possible processes including game test and review, may be content rating before the game is stored for service in cloud network 103. Game 118 may be analyzed by SW 114 in an automated or semi-automated fashion. Once rated for appropriate access, meaning age appropriateness, the game may be sent to GS 107 and assigned to a game engine like GE 110, and may be stored for service dependent upon the rating level or category. For example, categories may be rated for 13 years old or under, rated for 17, rated for 21, etc. Additional ratings may be created for subject matter in the game such as violence, weapons use, language, sexual content, and so on.

Once a game is rated and ready for first play it may be stored for service. The game may be streamed along with additional rating information to alert a player before join or launch, about the subjects or categories rated and the rating levels or values of each rated category. In one embodiment, a rated game is made available for play by the provider only to clients of an age that the rating defines as appropriate. In one embodiment, rating server 111 running SW 114 may be programmed by an administrator, such as one operating a laptop 123, within provider domain 102 to access or intercept game streams of online games that may have been played and are currently rated but were since updated by the developer with new content.

An administrator operating laptop 123 may use a client application, such as a rating service client application 125, and a browser 124 while connected in session with server 111 to program server 111 running RSW 114 to access and rate games by batch and according to schedule and or other criterion, such as number of games defined in a batch of games. It may also be enabled for an administrator operating laptop 123 to manually rate games using RSW client application 125 while connected to server 111 for access to content library 112. RSW client 112 may also be used to update rating rules, add content categories, add, remove, or update rating language, and so on. Rating may be done dynamically by intercepting a game stream of a known game and processing received content. The system may be programmed to rate any new or updated games that become known to the system, and may automatically rate games based on a programmed trigger event, or may rate games according to programmed schedule and or other criterion. The system may be scaled up as needed and used to manually or to semi-automatically rate games.

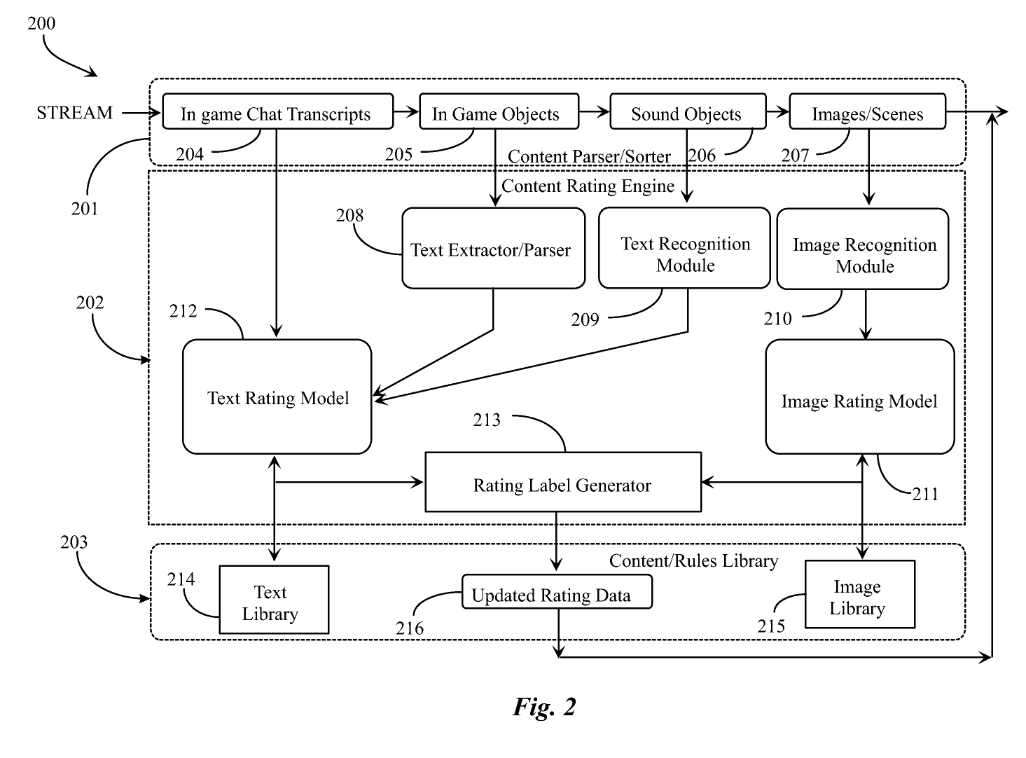

FIG. 2 is a block diagram 200 depicting automated rating by analyzing a video game stream according to an embodiment of the present invention. Block diagram 200 depicts a live video game stream (STREAM) being intercepted by rating SW, such as SW 114 on server 111 of FIG. 1. The video game stream may include in-game chat transcripts 204 recording online chat between game players during play of the game. The stream may include in-game objects 205 having text descriptions including titles and other embedded text attributes that may be extracted and rated. The video game stream may also include sound objects 206 that may include audio words and phrases that may be recognized using speech to text recognition technologies, and by comparison to stored standards. The intercepted stream may also include images or image scenes 207 that may be analyzed using optical image recognition technologies, and that may also be compared to stored standards.

An intercepted video game stream may be processed by a software content parser and or sorter 201 that may direct content to appropriate modules within a content rating engine 202 for text, audio, and image analysis. In-game chat transcripts 204 may be routed directly to a text rating module 212. Module 212 may have access to a text library 214, which may be part of a content/rules library 203. Content/rules library 203 may be analogous to content library 112 of FIG. 1. While a rules base is not depicted within content/rules library 203 they may be assumed present and accessible from each depicted content library. Text may be analyzed for curse words, racially-charged language content, sexual content, intent (phrase meaning), and more. In-game chat dialogue may in one embodiment be rated separately from native in-game content, where that rating may weigh on the rating of the native in-game content. In such a case a developer may determine to disallow in-game chat amongst the players.

In some embodiments, communication other than chat may be supported, and in chat and other communication modes, communications may be recorded and archived, and associated with specific times and games. These archives in embodiments of the invention may be searchable to use comments, words, phrases and descriptions, as well as opinions, about games, in the process of rating said games.

In-game objects 205 may include text attributes that are not visible to players but may be embedded in or otherwise included in metadata associated with an in-game object. For example, objects stored in a database may have specific names and descriptions, and in embodiments of the invention the names and descriptions may be extracted and used in comparisons, and in other aspects of rating games. Names and descriptions, for example, may be about weapons, pools of blood, and many other sorts of information pertinent to rating games for age suitability. In-game objects in the video stream may be directed, mapped, or routed to a text extractor and parsing module 208. The extracted text may then be directed, routed, or mapped to text rating module 212. Text rating module 212 may, in one implementation, keep text rating values created from analyzing externally introduced text (in-game chat) separate from rating values created from native text associated with in-game objects, wherein one of those rating values might be used as a weighting factor in adjusting the other rating value derived.

Sound objects 206 within the video stream may be directed to a text recognition module 209 that may analyze speech and recognize words that may be set to text for text rating. The text derived from the speech may be directed, routed or otherwise mapped to text rating module 212. In one embodiment text extracted from in-game objects 205 and text derived from sound objects 206 by recognition module 209 may be rated together as native content by rating module 212, whereby externally-introduced text from in-game chat transcripts 204 may be rated separately. In one implementation, rating module 212 may also be enabled to capture external comments associated with a rated game or a game that needs rating, and may rate that text along with chat transcripts as non-native content associated but not native to the game. Comments may include critiques, recommendations, opinions, complaints, and so on. These might be rated as non-native content wherein the rating value may be used as a weight factor to adjust the game content rating.

Images and image scenes 207 may be routed directed or mapped to an Image recognition module 210. Processed images may then be routed, directed or mapped to an Image rating module 211. Image rating module 211 may have access to an image library 215 analogous to content library 112 of FIG. 1. Rating values from Text rating module 212 and from image rating module 211 may be forwarded to a rating label generator 213. Rating label generator 213 may be enabled to generate a formal rating value and an associated description for that value such as what subjects are rated, overall ratings breakdown by subject, and age description information relative to the age of users appropriate for viewing and interacting with the rated content. Rating label generator 213 may output rating value and description as well as displayable text as updated rating data 216.

Updated rating data 216 may include the overall rating determination for the game, a breakdown of separated categories and associated ratings values, and any displayable warnings or rating-related messages and symbols that may be included in the video game screen, and may be displayed for users attempting to join such games. Therefore, the updated rating information may be immediately displayable in the rated video stream to end devices in real time. Rating label generator 213 may simultaneously update multiple game instances distributed over more than one server or game engine, such that all game instances are updated as soon as the information is available.

Measures to discourage or prevent inappropriate viewing and interaction with a rated game may be undertaken immediately in the event a running instance of a game is rated, while users are connected to the game. Ratings label information may appear in the game stream displayed on a user's device. If it is known that a user is not appropriate to interact or view under the updated rating, that user may be bumped from the game with a message displaying, such as the game you are playing has been updated in rating and you no longer have authorization to access it, or some like statement or message that precedes the bump action. In one implementation, a rated game may be updated if ratings rules change or if the developer has added any unrated content. Rating label generator 213 may also update a games link list with all of the appropriate rating labels and information for every game link listed where that game has been rated by the system of the present invention.

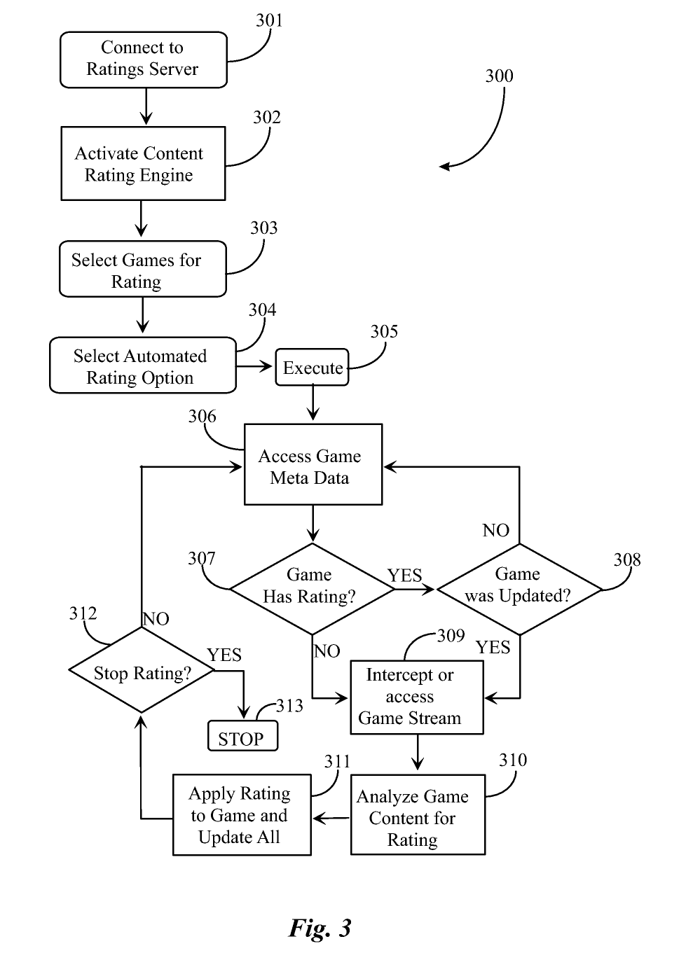

FIG. 3 is a process flow chart 300 depicting steps for accessing video games for the purpose of rating according to one aspect of practice of the present invention. In step 301, a user such as an administrator operating a computing appliance such as laptop 123 of FIG. 1, may connect online with a ratings server such as server 111 of FIG. 1 running rating software such as RSW 114. In this example, it may be assumed that a human operator may configure and activate the system to perform automated game rating. In one implementation, the administrator may have a local client application such as SW 125 of FIG. 1 to the rating SW on the server enabling the administrator to work within the local application on his or her appliance.

At step 302, the administrator may activate a content rating engine application on the server such as SW 114 of FIG. 1. The administrator may then select games for rating that may be presented in a list, stacked in a queue, held in a game server repository, or wherever the games might be accessed online. A user may select games according to batches, according to game category, according to game status (rated or not), etc. The user (administrator) may select an automated rating option such as scheduling rating activity for batches of games, rate all unrated games immediately, rate a specific number of games, rate only selected games, rate only updated games, etc. At step 305, the user may execute save or otherwise trigger the rating system into action.

At step 306, the rating system may access game meta data describing the game and any previous ratings history. At step 307, the system might determine as a result of looking at game meta data whether or not a game has a current rating. Meta data may also reveal whether a game was updated with new content since a last ratings pass was made on the game. If the system determines a game already has a rating the system may determine at step 308 whether the game was updated by the developer with any new content. If at step 308 the system determines that the rated game was not updated with any new content, the process may resolve back to step 306 where the meta data for the next game is accessed.

If at step 307 the system determines the game does not have a current formal rating, that game may be targeted for access of a game stream at step 309. A video game stream may be a test stream in one implementation that is designed for rating purposes before the game is made public. A video game stream may also be a live running game stream that may be accessed in the cloud and that may be streamed to and processed at the rating server before traveling on to a player's connected appliance. A generic game stream including the new content but excluding older and redundant content might be crafted at the game engine just for the purpose of rating at the rating server.

If at step 308 the rating system determines that a rated game has been recently updated with new content, the system may access the game stream or at least the unrated parts of it at step 309. At step 310 the system may analyze the video game content before and during rating processes. At step 311, the system may apply rating to a game and may update all game instances accessible to the server or any other instances online and serviceable.

At step 312, the system may determine whether to stop rating. At step 312 if the system determines to stop rating based on an order or trigger or manual interruption, or for some other reason, the process may end for that pass at step 313. If the system determines not to stop rating at step 312, the process may loop back to step 306 where the system accesses the metadata of a next game for rating. The process may cycle for a large number of games to be rated such as in a batch of games or all games on a storage medium, etc. In one embodiment games may be rated while they are currently running where the game streams accessed include components for rating and chat transcripts contributed into the stream by users. In another embodiment the chat transcripts might be intercepted and rated after they are archived at the server. In one embodiment a game stream or more than one game stream from a same game may be recorded and looped into the rating engine such that the rating occurs after user input has occurred relative to the stream.

In one embodiment, any game that is updated on a server is passed through the automatic ratings system of the invention just after update but before next play. In one embodiment, all games scheduled for deployment are automatically rated just after upload of those new games. In one embodiment, all games are rated periodically such as every 6 months, to account for possible administration changes to update methods, rating value criteria, rating rules, new subject matters rated, and the like.

It will be apparent to one with skill in the art that the automated rating system of the invention may be provided using some or all of the mentioned features and components without departing from the spirit and scope of the present invention. It will also be apparent to the skilled artisan that the embodiments described above are specific examples of a single broader invention that may have greater scope than any of the singular descriptions taught. There may be many alterations made in the descriptions without departing from the spirit and scope of the present invention.

It will be apparent to the skilled person that the arrangement of elements and functionality for the invention is described in different embodiments in which each is exemplary of an implementation of the invention. These exemplary descriptions do not preclude other implementations and use cases not described in detail. The elements and functions may vary, as there are a variety of ways the hardware may be implemented and in which the software may be provided within the scope of the invention. The invention is limited only by the breadth of the claims below.

1. An automated ratings system, comprising:
a network-connected computerized server;
software executing from a non-transitory medium on a processor in the server; and
a data repository storing standards for images, words and phrases for comparison;
wherein a video stream of a presentation to be rated is received and played, text, images, and voice words and phrases are compared with the standards stored in the data repository, and a rating is generated by a rating module for the presentation based on presence and quantity of the standard images, words and phrases noted in the presentation to be rated.

2. The system of claim 1 wherein the presentation is a video game, including in-game communication between players, and words and phrases noted in the communication are used in rating.

3. The system of claim 2 wherein the communication is through a chat application.

4. The system of claim 2 wherein communication between players is recorded and archived, and the system searches and uses content in the archived communication in the rating process.

5. The system of claim 1 wherein the presentation is a video game displaying objects having names and descriptions in a database, and the system extracts and considers the names and descriptions in the rating process.

6. The system of claim 1 wherein the software comprises a text extractor and parser, a text recognition module, an image recognition module, a text rating module, and an image rating module.

7. The system of claim 1 wherein a rating is determined separately for image, text and voice, and then combined by the rating module to determine an overall rating.

8. The system of claim 7 wherein certain images, words and phrases stored as standards are associated with a number, the rating module determines the instances of use in the presentation to be rated of the certain images, words and phrases, combines the numbers in a predetermined manner, and uses the combined numbers against a scale of age to generate an age appropriate rating for the presentation.

9. The system of claim 8 wherein the standards and the predetermined manner are editable.

10. The system of claim 1 wherein voice words and phrases are converted to text in the comparison and rating.

11. The system of claim 1 wherein presentations, including video games, are stored and played from a presentation engine hosted by a provider, and a presentation is automatically rated when first stored on the server for access.

12. The system of claim 11 wherein the presentation engine monitors editing of presentations, and presentations are re-rated after any instance of editing.

13. The system of claim 11 wherein presentations, including video games, are promoted on a web page hosted by the provider, enabling consumers to link to a consume the presentations, and wherein a rating determined by the rating engine is prominently displayed in the promotion.

14. An automated ratings method, comprising:
playing a video stream to be rated by a player operating in a network-connected computerized server;
comparing, by execution of software on a processor in the computerized server, text, images and voice words and phrases in the presentation, to standards stored in a data repository coupled to the computerized server; and
generating a rating by a rating module based on presence and quantity of the standard images, words and phrases noted in the presentation to be rated.

15. The method of claim 14 wherein the presentation is a video game, including in-game communication between players, and words and phrases noted in the communication are used in rating.

16. The method of claim 15 wherein the communication is through a chat application.

17. The method of claim 15 wherein communication between players is recorded and archived, and the system searches and uses content in the archived communication in the rating process.

18. The method of claim 14 wherein the presentation is a video game displaying objects having names and descriptions in a database, and the system extracts and considers the names and descriptions in the rating process.

19. The method of claim 14 wherein the software comprises a text extractor and parser, a text recognition module, an image recognition module, a text rating module, and an image rating module.

20. The method of claim 14 wherein a rating is determined separately for image, text and voice, and then combined by the rating module to determine an overall rating.

21. The method of claim 20 wherein certain images, words and phrases stored as standards are associated with a number, the rating module determines the instances of use in the presentation to be rated of the certain images, words and phrases, combines the numbers in a predetermined manner, and uses the combined numbers against a scale of age to generate an age appropriate rating for the presentation.

22. The method of claim 21 wherein the standards and the predetermined manner are editable.

23. The method of claim 19 wherein voice words and phrases extracted are converted to text in the comparison and rating.

24. The method of claim 14 wherein presentations, including video games, are stored and played from a presentation engine hosted by a provider, and a presentation is automatically rated when first stored on the server for access.

25. The method of claim 24 wherein the presentation engine monitors editing of presentations, and presentations are re-rated after any instance of editing.

26. The method of claim 24 wherein presentations, including video games, are selectable by linked indicia on a web page hosted by the provider, enabling consumers to link to and consume the presentations, and wherein a rating determined by the rating engine is prominently displayed in the indicia.
